(19) United States
(12) Patent Application Publication
(10) Pub. No.: US 2024/0327692 A1
(43) Pub. Date: Oct. 3, 2024

(54) Method for Reducing Sticking, Crusting and Clumping of Salt Stored in Salt Piles

(71) Applicant: Natural Alternatives, LLC, Lexington, KY (US)

(72) Inventor: Todd Bloomer, Lexington, KY (US)

(21) Appl. No.: 18/739,796

(22) Filed: Jun. 11, 2024

Related U.S. Application Data
(63) Continuation-in-part of application No. 18/236,139, filed on Aug. 21, 2023.
(60) Provisional application No. 63/400,549, filed on Aug. 24, 2022.

(51) Int. Cl. C09K 3/18

(52) U.S. Cl. CPC C09K 3/185

(57) ABSTRACT

A formulation for treating salt to reduce sticking, crusting and clumping of stored salt caused by absorption of water from the air includes corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, as well as admixtures thereof exhibiting anti-sticking, anti-crusting and anti-clumping properties when applied to the salt and mixtures thereof.

### RELATED APPLICATIONS

This application is a continuation-in-part (CIP) of U.S. patent application Ser. No. 18/236,139, filed on Aug. 21, 2023, which claims priority to U.S. Provisional Patent Application Ser. No. 63/400,549, filed on Aug. 24, 2022, both of which are hereby incorporated by reference.

### TECHNICAL FIELD

This document relates generally to field of salt storage and, more particularly, to a method for treating salt to reduce sticking, crusting and clumping of stored salt caused by the absorption of water from the air in high humidity environments.

### BACKGROUND

Salt is a hygroscopic material meaning salt will absorb moisture from the air when the humidity climbs above 75%. As a result, on humid days, salt piles can collect large amounts of water from the air. On lower humidity days, that previously absorbed moisture can evaporate back into the air, causing a crust to form. Over time and multiple absorption and evaporation cycles, the hard crust can become very thick. This can and often does lead to the formation of large clumps of salt that can weigh several hundred pounds. Such clumps can be quite difficult to handle and may, in fact, represent a substantial safety hazard. Economic loss comes from these clumps having to be smashed with front end loaders and the dust is dissolved by rain or blows away by the wind causing environmental concerns.

While the above concerns may be somewhat ameliorated by covering the salt pile with an appropriate material, such as a waterproof tarpaulin, air, with its attendant humidity, can still permeate the salt pile and the issue still remains one of concern that has not been adequately addressed to date.

Other efforts to address this problem include adding the anticaking agent, yellow prussiate of soda (YPS), also known as sodium ferrocyanide, to the salt. Very little if any has been written or studied for the use of highway deicing salt which contains about 15% max of YPS or approximately 200 ppm. What is known and documented very well is YPS, after exposure to sunlight or acid, will break down and produce hydrogen cyanide gas which is toxic. Toxic effects have been seen in as little as 1 PPM according to the US Geological Survey. The US Geological Survey calls it Photo Enhanced toxicity.

Highway salt that is used and spread on highways and stored in covered piles exposed to the sun can produce the same effect. This is especially true when the spread salt is left on the road or rests in ditches and/or along the sides of roads where sunlight has the potential to cause hydrogen cyanide gas. This is well documented in studies looking at the effects of UVB radiation on toxicity of YPS in firefighting chemicals in which YPS is used as a corrosion inhibitor. The studies clearly show that fish, frogs, aquatic creatures and organisms were adversely affected by its use when the YPS was exposed to sunlight. Advantageously, the formulations disclosed in the present document are effective anticaking agents that are less potentially toxic and less harmful than YPS to the environment and fish, frogs, aquatic creatures and organisms.

This document relates to a new and improved method for treating salt and substantially reducing and often completely eliminating the sticking, crusting and clumping of stored salt that is caused by the absorption of water from the air in high humidity environments. As an added benefit, the formulation used to coat the salt and reduce the adverse effects of high humidity on salt piles also (a) functions as an anti-corrosive agent inhibiting corrosion of metal machinery and components used to handle the salt and (b) exhibits deicing properties of its own enhancing the deicing properties of the salt when subsequently spread on roadways.

### SUMMARY

In accordance with the purposes and benefits set forth herein, a new and improved formulation is provided for treating salt to reduce sticking, crusting, and clumping of stored salt caused by absorption of water from the air. That formulation comprises, consists of or consists essentially of desugared sugar beet molasses, admixtures of desugared sugar beet molasses exhibiting anti-sticking, anti-crusting and anti-clumping properties when applied to the salt, desugared sugar beet molasses processed to reduce pectin levels, admixtures of desugared sugar beet molasses processed to reduce pectin levels and also exhibiting anti-sticking, anti-crusting and anti-clumping properties when applied to the salt, sugar cane molasses, admixtures of sugar cane molasses exhibiting anti-sticking, anti-crusting and anti-clumping properties when applied to the salt, concentrated molasses solids (CMS), concentrated bypass syrup (CBS), concentrated syrup byproduct (CBS), raffinate, concentrated molasses solids (CMS) processed to remove chlorides, concentrated syrup byproduct (CBS) processed to remove chlorides, raffinate processed to remove chlorides, potassium acetate, glycerin, corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof. The formulation may have a viscosity of about 25 secs with a Zahn #2 cup and a pH of about 6.8 to about 9.7 and is non-corrosive.

In at least one of the many possible embodiments of the formulation, the formulation comprises about 40% to about 60% solids. In at least some embodiments, the admixtures include, a surfactant, an emulsifier, a viscosity modifier and combinations thereof. The surfactant may be selected from a group consisting of an anionic surfactant, a non-ionic surfactant, a amphoteric surfactant and combinations thereof. In at least one useful embodiment the surfactant is a polyethylene glycol ester surfactant.

The emulsifier may be selected from a group of emulsifiers consisting of a polysorbate, canola oil, lecithin, glycerin and combinations thereof. The viscosity modifier may be selected from a group consisting of a cellulose gel, a formate, an acetate, an organic acid and combinations thereof.

In many of the possible embodiments, the pectin level of the formulation may have been reduced below naturally occurring levels. In some embodiments, the pectin levels are reduced below 0.1 weight percent of the formulation. In some formulations, the pectin levels are reduced below 0.08 weight percent of the formulation.

In accordance with an additional aspect, a method of reducing sticking, crusting and clumping of stored aggregate salt, comprises, consists of or consists essentially of treating the stored aggregate salt with a formulation that exhibits anti-sticking, anti-crusting and anti-clumping properties when applied to the aggregate salt prior to the aggregate salt being stored in a pile. As noted above, that formulation comprises, consists of or consists essentially of desugared sugar beet molasses, admixtures of desugared sugar beet molasses exhibiting anti-sticking, anti-crusting and anti-clumping properties when applied to the salt, desugared sugar beet molasses processed to reduce pectin levels, admixtures of desugared sugar beet molasses processed to reduce pectin levels and also exhibiting anti-sticking, anti-crusting and anti-clumping properties when applied to the salt, sugar cane molasses, admixtures of sugar cane molasses exhibiting anti-sticking, anti-crusting and anti-clumping properties when applied to the salt, concentrated molasses solids (CMS), concentrated bypass syrup (CBS), concentrated syrup byproduct (CSB), raffinate, concentrated molasses solids (CMS) processed to remove chlorides, concentrated syrup byproduct (CSB) processed to remove chlorides, raffinate processed to remove chlorides, potassium acetate, glycerin, corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof. The formulation may have a viscosity of about 25 secs with a Zahn #2 cup and a pH of about 6.8 to about 9.7 and is non-corrosive.

In the following description, there are shown and described several different embodiments of the new and improved formulation for treating salt to reduce sticking, crusting and clumping of stored salt caused by absorption of water from the air and related method of reducing sticking, crusting and clumping of stored aggregate salt. As it should be realized, the formulation and method are capable of other, different embodiments and their several details are capable of modification in various, obvious aspects all without departing from the formulation and method as set forth and described in the following claims. Accordingly, the drawings and descriptions should be regarded as illustrative in nature and not as restrictive.

### DETAILED DESCRIPTION

A formulation is used in a method of treating salt to reduce sticking, crusting and clumping of stored salt caused by the absorption of water from the air in high humidity environments. That formulation may be generally described as comprising, consisting of or consisting essentially of: desugared sugar beet molasses, admixtures of desugared sugar beet molasses exhibiting anti-sticking, anti-crusting and anti-clumping properties when applied to the salt, desugared sugar beet molasses processed to reduce pectin levels, admixtures of desugared sugar beet molasses processed to reduce pectin levels and also exhibiting anti-sticking, anti-crusting and anti-clumping properties when applied to the salt, sugar cane molasses, admixtures of sugar cane molasses exhibiting anti-sticking, anti-crusting and anti-clumping properties when applied to the salt, concentrated molasses solids (CMS), concentrated bypass syrup (CBS), concentrated syrup byproduct (CSB), raffinate, concentrated molasses solids (CMS) processed to remove chlorides, concentrated syrup byproduct (CSB) processed to remove chlorides, raffinate processed to remove chlorides, potassium acetate, glycerin, corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof.

The formulation may also have been processed to reduce pectin levels. Thus, the formulation may include any of the following that have been processed to reduce pectin levels: corn syrup, corn molasses, (brown) rice syrup, maple syrup, sorghum molasses, agave syrup, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt,

The formulation may have a viscosity of about 25 secs with a Zahn #2 cup and a pH of about 6.8 to about 9.7 and be non-corrosive. The formulation may have about 40%-75% solids for best performance and cost. Some particularly useful formulations have about 50% solids.

The formulation may be made by blending the neet solution with glycerin, a formate, or acetate and adding water to reduce the viscosity. The viscosity is very important because the material will be used in freezing temperatures. If not blended properly the solution will not be sprayable. The formulation will have the capabilities of sticking to and coating the aggregate salt to which it is applied. The formulation will also have the characteristics of being able to be pumped in cold weather and being able to stick in warmer weather. The formulation will be cost effective. The formulation should be of non-chloride and non-corrosivity to metal surfaces.

Materials useful in the admixtures of desugared sugar beet molasses include, but are not necessarily limited to, surfactants, emulsifiers, and viscosity modifiers as well as combinations thereof. The surfactants help to enhance the coating of the salt with the formulation making the salt easier to coat. Surfactants that may be used in the formulation include, but are not necessarily limited to an anionic surfactant, a cationic surfactant, a non-ionic surfactant, an amphoteric surfactant and combinations thereof. This includes, but is not necessarily limited to, polyethylene glycol ester surfactants. The surfactant or surfactants may comprise between about 1.0 and about 25.0 weight percent of the formulation.

Emulsifiers can also be useful in the formulation, including, particularly, the admixtures of the desugared sugar beet molasses. Emulsifiers function to increase the efficiency of the solutions which allows for easier handling especially when its cold. Emulsifiers useful in the formulations include, but are not necessarily limited to polysorbates, canola oil, lecithin, glycerin and combinations thereof. The emulsifier or emulsifiers may comprise between about 1.0 and about 65.0 weight percent of the formulation.

Viscosity modifiers useful to lower the viscosity and improve the handling and spraying properties of the formulations include, but are not necessarily limited to cellulose gels, formates, acetates, organic acids (e.g. citric) and combinations thereof. The viscosity modifier or viscosity modifiers may comprise between about 1.0 and about 35.0 weight percent of the formulation.

Sugar beet pulp, upon sugar extraction consists of almost 15-30% pectin (dry basis). In certain situations, this naturally occurring pectin in the desugared sugar beet molasses and the desugared sugar beet molasses admixtures has been found to adversely affect the salt coating properties of the formulation. Thus, in some instances desugared sugar beet molasses and desugared sugar beet molasses admixtures that have undergone processing of a type known in the art to reduce pectin levels below naturally occurring levels are preferred formulations for use in the present method of treating salt to reduce sticking, crusting and clumping of stored salt caused by the absorption of water from the air in high humidity environments. Preferably, pectin levels in the formulations are reduced below 0.5 weight percent. In some embodiments, the pectin levels are reduced below about 0.1 weight percent. In other embodiments, pectin levels are reduced below. 08 weight percent of the formulation.

In accordance with an additional aspect, a method of treating salt to reduce sticking, crusting and clumping of stored salt caused by the absorption of water from the air in high humidity environments is provided. That method comprises the step of treating the salt with a formulation exhibiting anti-sticking, anti-crusting and anti-clumping properties when applied to the salt prior to the salt being stored in a pile. The formulation used in the method may be the formulation described elsewhere in this document.

More particularly, the method may include the steps of applying the formulation to the salt while mechanically mixing the salt. In one possible embodiment, between about 4-6 gallons of formulation is applied per ton of aggregate salt. In one possible embodiment, the formulation is applied by spraying. In at least one possible embodiment of the method, the mechanical mixing is performed by mechanical conveying of the salt during application of the formulation. This may be done while the salt is delivered via conveyor to a salt pile and sprayed at the point it contacts and is spread across the conveyor or as it leaves the conveyor to be mixed at the salt pile. In another possible embodiment, a loader is used to mechanically mix the salt as the formulation is being applied.

The mechanical mixing during formulation application ensures more even and thorough coating of the salt before the salt is delivered to the salt pile. The resulting protective coating of formulation allows for maximum benefit and reduction or elimination of sticking, crusting and clumping salt over longer periods of time. This simplifies the handling of the salt when it is subsequently loaded into trucks for application to the roadways often weeks or months later.

Since the formulation coating the salt has anti-corrosive properties, loaders, dump trucks and other metal equipment used to handle the salt downstream from the salt pile are at least somewhat protected from the corrosive action of the chlorides in the salt. As an additional benefit, the coating formulation exhibits deicing properties of its own enhancing the deicing properties of the salt when spread on roadways.

Salt coated with the formulation is also disclosed.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a surfactant”, as used herein, may also refer to, and encompass, a plurality of surfactants.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the formulation and method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A formulation for treating salt to reduce sticking, crusting and clumping of stored salt caused by absorption of water from the air, comprising:
corn syrup, corn molasses, sorghum molasses, pomegranate molasses, carob molasses, date molasses, desugared corn syrup, desugared corn molasses, desugared (brown) rice syrup, desugared maple syrup, desugared sorghum molasses, desugared agave syrup, desugared pomegranate molasses, desugared carob molasses, desugared date molasses, admixtures of corn syrup exhibiting anti-sticking, anti-crusting and anti-clumping properties when applied to the salt, admixtures of corn molasses exhibiting anti-sticking, anti-crusting and anti-clumping properties when applied to the salt, admixtures of (brown) rice syrup exhibiting anti-sticking, anti-crusting and anti-clumping properties when applied to the salt, admixtures of maple syrup exhibiting anti-sticking, anti-crusting and anti-clumping properties when applied to the salt, admixtures of sorghum molasses exhibiting anti-sticking, anti-crusting and anti-clumping properties when applied to the salt, admixtures of agave syrup exhibiting anti-sticking, anti-crusting and anti-clumping properties when applied to the salt, admixtures of pomegranate molasses exhibiting anti-sticking, anti-crusting and anti-clumping properties when applied to the salt, admixtures of carob molasses exhibiting anti-sticking, anti-crusting and anti-clumping properties when applied to the salt, admixtures of date molasses exhibiting anti-sticking, anti-crusting and anti-clumping properties when applied to the salt, admixtures of desugared corn syrup exhibiting anti-sticking, anti-crusting and anti-clumping properties when applied to the salt, admixtures of desugared corn molasses exhibiting anti-sticking, anti-crusting and anti-clumping properties when applied to the salt, admixtures of desugared (brown) rice syrup exhibiting anti-sticking, anti-crusting and anti-clumping properties when applied to the salt, admixtures of desugared maple syrup exhibiting anti-sticking, anti-crusting and anti-clumping properties when applied to the salt, admixtures of desugared sorghum molasses exhibiting anti-sticking, anti-crusting and anti-clumping properties when applied to the salt, admixtures of desugared agave syrup exhibiting anti-sticking, anti-crusting and anti-clumping properties when applied to the salt, admixtures of desugared pomegranate molasses exhibiting anti-sticking, anti-crusting and anti-clumping properties when applied to the salt, admixtures of desugared carob molasses exhibiting anti-sticking, anti-crusting and anti-clumping properties when applied to the salt, admixtures of desugared date molasses exhibiting anti-sticking, anti-crusting and anti-clumping properties when applied to the salt, and mixtures thereof; and
wherein the formulation has a viscosity of about 25 secs with a Zahn #2 cup and a pH of about 6.8 to about 9.7.

2. The formulation of claim 1 wherein the formulation has been processed to reduce pectin levels.

3. The formulation of claim 1, further having 40% to 75% solids.

4. The formulation of claim 1, wherein the formulation further includes, a surfactant, an emulsifier, a viscosity modifier or combinations thereof.

5. The formulation of claim 4, wherein the surfactant is selected from a group consisting of an anionic surfactant, a cationic surfactant, a non-ionic surfactant, an amphoteric surfactant and combinations thereof.

6. The formulation of claim 4, wherein the surfactant is a polyethylene glycol ester surfactant.

7. The formulation of claim 4, wherein the emulsifier is selected from a group of emulsifiers consisting of a polysorbate, canola oil, lecithin, glycerin and combinations thereof.

8. The formulation of claim 4, wherein the viscosity modifier is selected from a group consisting of a cellulose gel, a formate, an acetate, an organic acid and combinations thereof.

9. The formulation of claim 1, wherein pectin level of the formulation has been reduced below naturally occurring levels.

10. The formulation of claim 1, wherein pectin level of the formulation has been reduced below 0.5 weight percent of the formulation.

11. The formulation of claim 1 wherein pectin level of the formulation has been reduced below 0.1 weight percent of the formulation.

12. The formulation of claim 1, wherein pectin level of the formulation has been reduced below 0.08 weight percent of the formulation.

13. A method reducing sticking, crusting and clumping of stored aggregate salt, comprising: treating the stored aggregate salt with a formulation as set forth in claim 1 that exhibits anti-sticking, anti-crusting and anti-clumping properties when applied to the aggregate salt prior to the aggregate salt being stored in a pile.

14. The method of claim 13, further including applying the formulation to the aggregate salt while mechanically mixing the aggregate salt.

15. The method of claim 13, further including applying between about 4-6 gallons of the formulation per ton of aggregate salt.

16. The method of claim 15, wherein the applying is by spraying.

17. The method of claim 13, including applying the formulation to the aggregate salt as the aggregate salt is spread across a conveyor for transfer to the pile.

18. The method of claim 13, including applying the formulation to the aggregate salt as the aggregate salt is discharged from a conveyor onto the salt pile.
